(19) United States
(12) Patent Application Publication
(10) Pub. No.: US 2014/0013422 A1
(43) Pub. Date: Jan. 9, 2014

(54) Continuous Multi-factor Authentication

(71) Applicants: Scott Janus, Rocklin, CA (US); Kenneth T. Layton, Chandler, AZ (US); Michael A. Goldsmith, Lake Oswego, OR (US)

(72) Inventors: Scott Janus, Rocklin, CA (US); Kenneth T. Layton, Chandler, AZ (US); Michael A. Goldsmith, Lake Oswego, OR (US)

(21) Appl. No.: 13/540,869

(22) Filed: Jul. 3, 2012

(51) Int. Cl. G06F 21/31

(52) U.S. Cl. CPC G06F 21/31
USPC 726/19

(57) ABSTRACT

A method and computing device for continuous multi-factor authentication are included in which a plurality of valid authentication credentials may be detected. Also, an authorized user may be detected within a viewing area. Additionally, an unauthorized object may be detected in the viewing area. Furthermore, a display device may be prevented from displaying content.

### BACKGROUND

1. Field

This disclosure relates generally to authentication in a computing system and more specifically, but not exclusively, to continuous multi-factor authentication in a computing system.

2. Description

Various authentication methods have been utilized to protect confidential content. However, many of the authentication methods can allow unauthorized users to circumvent the authentication process. For example, some authentication methods attempt to verify the identity of a user based on user-provided credentials. In some instances, computing systems may request a username and password combination to access certain content. Therefore, the user is considered an authorized user if valid authentication credentials are provided. However, unauthorized users can obtain the authentication credentials in some instances and gain access to confidential content.

Some authentication methods include more advanced attempts to verify that the user of a computing system is authorized to view confidential content. For example, advanced authentication methods can include scanning the fingerprints or retinas of users, verifying software tokens, or authenticating the device accessing the confidential content. However, even the advanced authentication methods can be circumvented because the authentication process only initially verifies that an authorized user is accessing the confidential content. Therefore, unauthorized users may gain access to a computing system after the initial authorization process.

In an attempt to prevent unauthorized users from gaining access to a computing system, some authentication methods may continuously monitor physiological attributes of the authorized user. However, the continuous authentication methods only detect whether an authorized user is currently accessing confidential content on a computing system. The continuous authentication methods do not detect unauthorized individuals or recording devices present in the viewing area of the display device of a computing system. Therefore, in some instances, an authorized user may allow an unauthorized user to view confidential content by allowing the unauthorized user in the viewing area of a display device.

### BRIEF DESCRIPTION OF THE DRAWINGS

The following detailed description may be better understood by referencing the accompanying drawings, which contain specific examples of numerous objects and features of the disclosed subject matter.

FIG. 1 is a block diagram of an example of a computing system that includes continuous multi-factor authentication;

FIG. 2 is a process flow diagram illustrating an example of a method for continuous multi-factor authentication;

FIGS. 3A, 3B and 3C illustrate an example of an overhead view of a computing system that includes continuous multi-factor authentication; and

FIG. 4 is a block diagram depicting an example of a tangible, non-transitory, computer-readable medium that allows continuous multi-factor authentication.

### DETAILED DESCRIPTION

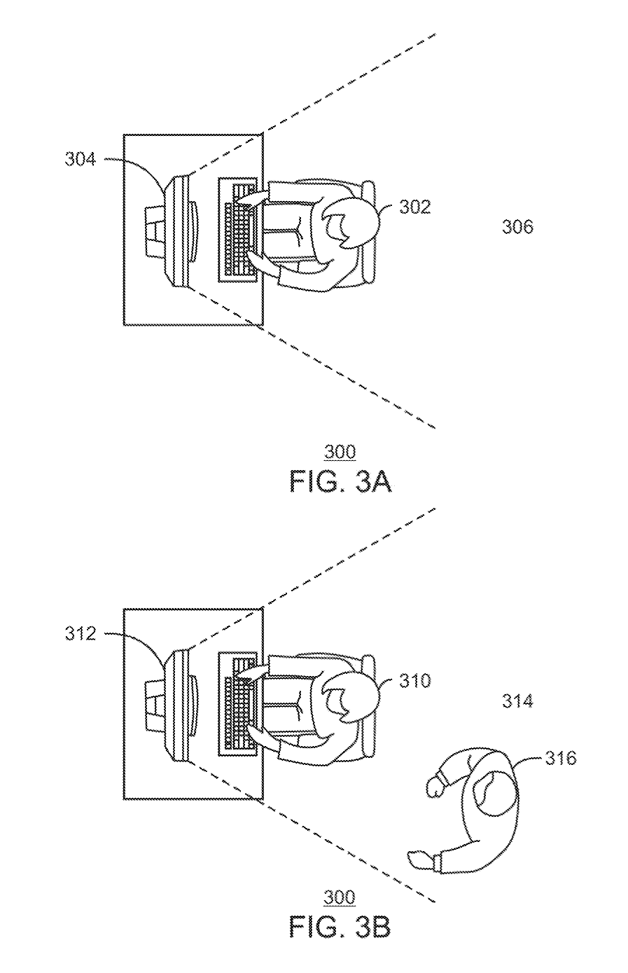

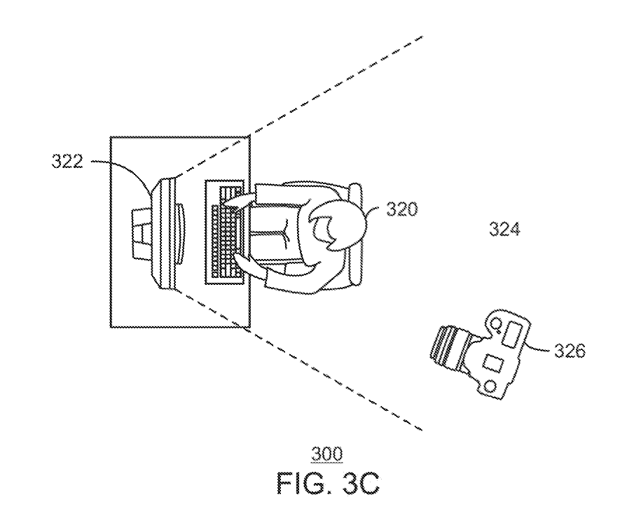

According to embodiments of the subject matter disclosed in this application, continuous multi-factor authentication can be utilized to prevent unauthorized users from viewing confidential content. The continuous multi-factor authentication involves detecting unauthorized objects,such as unauthorized users (also referred to herein as unauthorized individuals) or unauthorized devices, in a viewing area. A viewing area, as defined herein, includes a three dimensional space proximate a display device, in which individuals or devices can view the content displayed on the display device. Examples of viewing areas are illustrated in FIGS. 3A, 3B, and 3C.

Reference in the specification to “one embodiment” or “an embodiment” of the disclosed subject matter means that a particular feature, structure, or characteristic described in connection with the embodiment is included in at least one embodiment of the disclosed subject matter. Thus, the phrase “in one embodiment” may appear in various places throughout the specification, but the phrase may not necessarily refer to the same embodiment.

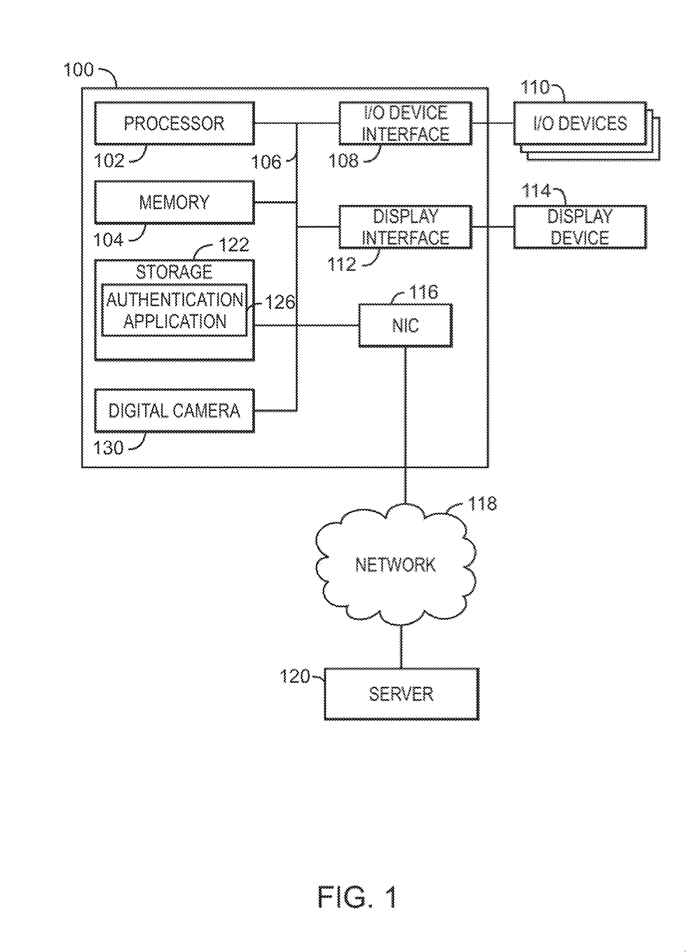

FIG. 1 is a block diagram of an example of a computing system that includes continuous multi-factor authentication. The computing system 100 may be, for example, a mobile phone, laptop computer, desktop computer, or tablet computer, among others. The computing system 100 may include a processor 102 that is adapted to execute stored instructions, as well as a memory device 104 that stores instructions that are executable by the processor 102. The processor 102 can be a single core processor, a multi-core processor, a computing cluster, or any number of other configurations. The memory device 104 can include random access memory (e.g., SRAM, DRAM, zero capacitor RAM, SONOS, eDRAM, EDO RAM, DDR RAM, RRAM, PRAM, etc.), read only memory (e.g., Mask ROM, PROM, EPROM, EEPROM, etc.), flash memory, or any other suitable memory systems. The instructions that are executed by the processor 102 may be used to implement a method that includes managing content.

The processor 102 may be connected through a system bus 106 (e.g., PCI, ISA, PCI-Express, HyperTransport®, NuBus, etc.) to an input/output (I/O) device interface 108 adapted to connect the computing system 100 to one or more I/O devices 110. The I/O devices 110 may include, for example, a keyboard and a pointing device, wherein the pointing device may include a touchpad or a touchscreen, among others. The I/O devices 110 may be built-in components of the computing system 100, or may be devices that are externally connected to the computing system 100.

The processor 102 may also be linked through the system bus 106 to a display interface 112 adapted to connect the computing system 100 to a display device 114. The display device 114 may include a display screen that is a built-in component of the computing system 100. The display device 114 may also include a computer monitor, television, or projector, among others, that is externally connected to the computing system 100. The processor 102 may also be linked through the system bus 106 to a digital camera 130 adapted to receive digital images. In some embodiments, the display device 114 may include a digital camera.

A network interface card (NIC) 116 may be adapted to connect the computing system 100 through the system bus 106 to a network 118. The network 118 may be a wide area network (WAN), local area network (LAN), or the Internet, among others. Through the network 118, the computing system 100 may communicate with a server 120.

The storage device 122 can include a hard drive, an optical drive, a USB flash drive, an array of drives; or any combinations thereof. The storage device 122 may include an authentication application 126 that is adapted to perform the continuous multi-factor authentication as described herein. The authentication application 126 may obtain authentication information from the I/O devices 110, the server 120, the display device 114, and/or the digital camera 130. For example, the authentication application 126 may receive authentication credentials that are provided by a user through one or more of the I/O devices 110. Authentication credentials, as defined herein, include information provided by a user to verify that the user is authorized to view confidential content. For example, a username and password can be authentication credentials. Additionally, the authentication application 126 may receive authentication credentials from a server 120. The authentication credentials obtained from the server 120 can be compared to the authentication credentials provided by a user to verify if the user provided authentication credentials are valid. The authentication application 126 may also receive images from the digital camera 130. The authentication application 126 can analyze the images to determine if unauthorized objects are located in the viewing area of a display device 114.

It is to be understood that the block diagram of FIG. 1 is not intended to indicate that the computing system 100 is to include all of the components shown in FIG. 1. Rather, the computing system 100 can include fewer or additional components not illustrated in FIG. 1 (e.g., depth sensors, cameras, additional network interfaces, etc.). Furthermore, any of the functionalities of the authentication application 126 may be partially, or entirely, implemented in hardware and/or in the processor 102. For example, the functionality may be implemented with an application specific integrated circuit, in logic implemented in the processor 102, in a display device 114, in a digital camera 130, among others.

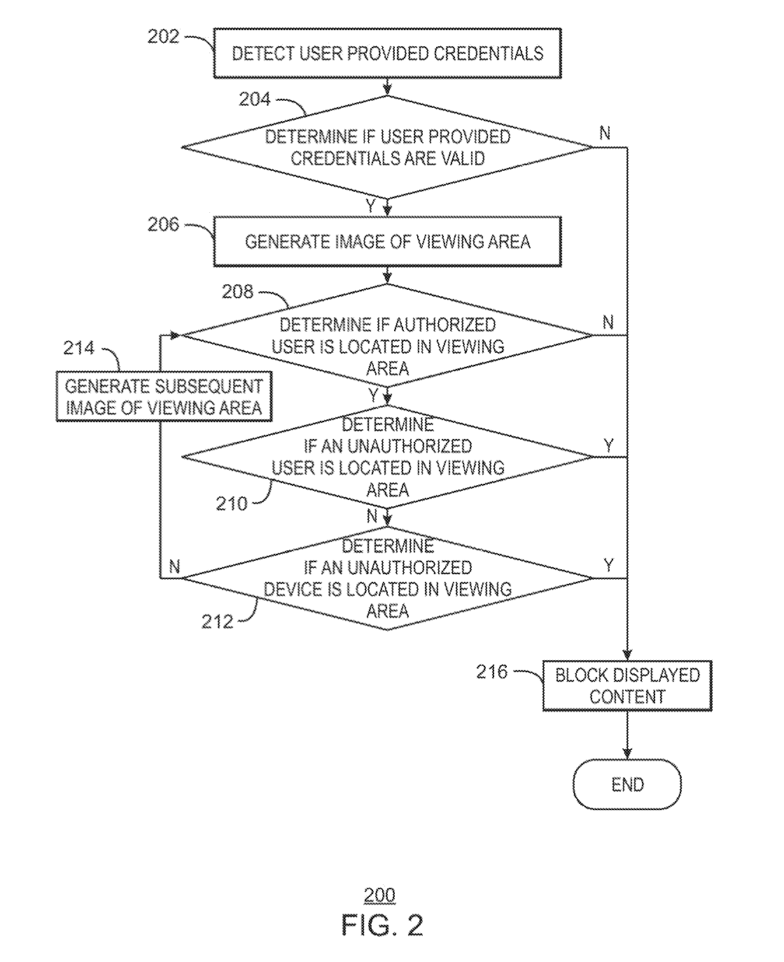

FIG. 2 is a process flow diagram illustrating an example of a method for continuous multi-factor authentication. The method for continuous multi-factor authentication may be implemented with a computing system 100, in which an authentication application 126 receives authentication data from a digital camera 130, I/O devices 110 and/or a server 120. Authentication data, as referred to herein, includes any authentication credentials, images, or any other information that can identify an authorized user.

At block 202, user provided credentials are detected. In some embodiments, the user provided credentials may include a username and password combination. In other embodiments, the user provided credentials may include a fingerprint of the user, which can be compared to the fingerprints of all authorized users. The user provided credentials may also include any other information that can identify authorized users, such as retina images, security tokens, and personal identification numbers, among others.

At block 204, it is determined if the credentials provided by the user are valid. In some embodiments, the credentials provided by a user are compared to credentials of authorized users stored within storage, i.e. 122. For example, three users may be authorized to access a confidential document. Each authorized user may have a separate username and password combination that is used to access the confidential document. When user provided credentials are detected, the three username and password combinations in this example may be retrieved from storage for comparison to the user provided credentials. In other embodiments, the authorization credentials may be stored in a server, i.e. 120. For example, four username and password combinations of authorized users may be stored in a server. The user provided credentials can then be compared to the authorized user credentials stored in the server to determine if the user is authorized to view confidential content. If the user does not provide valid credentials, the process continues at block 216 and the confidential documents are not displayed. If the user does provide valid credentials, the process continues at block 206.

At block 206, an image of the viewing area is generated. In some embodiments, a digital camera is located proximate the display device. The digital camera can then record an image of the viewing area proximate the display device. If the camera is unable to capture the viewing area in a single image, the camera may be configured to rotate to different angles. By capturing images from different angles, the camera can generate a larger image of the viewing area. In other embodiments, several cameras may be located proximate the display device, so that the cameras can record a set of images of the viewing area. The set of images can then be combined to generate a larger image of the viewing area.

At block 208, it is determined if an authorized user is located within the viewing area. As discussed above, the viewing area includes a three dimensional space proximate a display device, in which individuals or devices can view the display device. The viewing area is discussed in more detail below in relation to FIGS. 3A, 3B and 3C, which include illustrations of viewing areas. A determination of whether an authorized user is located within the viewing area can be based on authentication data received from various devices. In some embodiments, a digital camera is located proximate the display device. The digital camera can capture images that can be used to generate an image of the viewing area. The authentication application can then detect physical characteristics of the user in the viewing area at the moment the user provides authentication credentials. For example, the digital camera may utilize facial recognition technologies, so that various facial features of the user can be detected after the user has provided valid authentication credentials.

In some embodiments, the physical characteristics of the user that entered valid authentication credentials are then compared to physical characteristics of each authorized user. For example, facial features of each authorized user may be stored in storage 122 along with a corresponding username and password combination. The facial features of the user can then be compared to the facial features of each authorized user. This can prevent an unauthorized user from viewing confidential content by providing an authorized user's valid authentication credentials. Therefore, the authentication application 126 can verify the user is authorized to view content based on physical features of the user in addition to authentication credentials. If the user of the computing system 100 is an authorized user, the process continues at block 210. If the user of the computing system 100 is not an authorized user, the process continues at block 216 and the confidential content is not displayed.

At block 210, it is determined if an unauthorized user is located in the viewing area. As discussed above, the authentication application 126 can determine if the user of a computing system is an authorized user based on physical features detected in an image. In some embodiments, the authentication application 126 can also determine if any unauthorized users are located within the viewing area. For example, an unauthorized user may attempt to view a confidential document by standing behind an authorized user seated in front of a computing system. The authentication application 126 can detect the physical features of the unauthorized user in the viewing area and block the confidential content from being displayed. In other embodiments, the authentication application 126 can determine the depth of each object within the viewing area. For example, the authentication application 126 may determine that an object in the viewing area is an authorized user that is located five feet from the display device. In other embodiments, the digital camera 130 may include depth sensors that provide additional data related to the depth of objects in the viewing area to the authentication application 126. Therefore, some embodiments may determine that the viewing area does not extend beyond a certain distance from the display device. For example, unauthorized users located forty feet from a display device may be detected in an image. The authentication application 126 may determine that the unauthorized users cannot view the confidential content from that distance. Therefore, the authentication application 126 may not block any of the content being displayed. If an unauthorized user is determined to be in the viewing area, the process continues at block 216. If there are not any unauthorized users in the viewing area, the process continues at block 212.

At block 212, it is determined if an unauthorized device is located in the viewing area. In some embodiments, the authentication application 126 can monitor all of the objects in the viewing area. For example, the authentication application 126 may detect a reflection from an optical lens within the viewing area. The optical lens may be determined to be an unauthorized device that cannot view the confidential content because the optical lens may be attached to a recording device. In some embodiments, an authorized optical lens may be allowed in the viewing area. The optical lens can be determined to be authorized based on physical characteristics of the optical lens. For example, a barcode representing authorized devices may be placed proximate the optical lens to indicate the recording device attached to the optical lens is authorized to view the confidential documents being displayed. In other embodiments, the authentication application 126 can detect unauthorized recording devices based on the physical characteristics of the recording devices. For example, authorized recording devices may have a unique shape or identifying element. The authentication application 126 can detect the shape or identifying element of the recording device and make a determination of whether the recording device is an authorized device or unauthorized device. If the viewing area does not include an unauthorized device, the process continues at block 214. However, if an unauthorized device is detected in the viewing area, the process continues at block 216.

At block 214, a subsequent image of the viewing area is generated. The process of generating subsequent images allows the authentication application 126 to continuously monitor the viewing area. The process can then determine if the user is still located in the viewing area at block 208. Therefore, if the user leaves the viewing area of the computing system 100, the process continues at block 216 and the confidential documents are blocked from view. Also,the authentication application 126 may continuously monitor the viewing area for additional users. For example, a second user may appear in the viewing area behind an authorized user. Since images of the viewing area are continuously captured, the authentication application 126 can detect the second user is an unauthorized user and block the display of confidential content. In other examples, a second user may appear in the viewing area behind an authorized user seated in front of a computing system. The authentication application 126 may receive an image of the viewing area and determine based on physical characteristics that the second user is an authorized user. In this example, the confidential content is then viewable to both authorized users. Therefore, multiple authorized individuals and authorized devices may be located in the viewing area.

At block 216, the confidential content is blocked from view in response to an unauthorized object in the viewing area. In some embodiments, the confidential content is no longer viewable because the display device 114 displays a single color, such as black or red, on the display device. In other embodiments, the authentication application 126 can detect a portion of the screen that is displaying confidential content and only that portion of the display device 114 displays a single color. For example, a confidential document may be located in the background of the display device 114. The confidential document may only be visible within the top right portion of the display device 114, so only the top right portion of the display device 114 may display a single color. In some embodiments, the authentication application 126 may prompt the user for authentication credentials after an unauthorized individual or unauthorized device has been detected in the viewing area. In other embodiments, the confidential content may be displayed after the unauthorized user and/or unauthorized devices have been removed from the viewing area. Similarly, if the confidential content is blocked from view because the user has left the viewing area, the confidential content may be displayed after the user has returned to the viewing area.

The process flow diagram of FIG. 2 is not intended to indicate that the operations of the method 200 are to be executed in any particular order, or that all of the operations of the method 200 are to be included in every case. For example, the authentication application 126 may determine if an unauthorized device is in the viewing area prior to determining if an unauthorized user is in the viewing area. Further, any number of additional operations may be included within the method 200, depending on the specific application.

FIGS. 3A, 3B and 3C illustrate an example of an overhead view of a computing system that includes continuous multi-factor authentication. In FIG. 3A, a user 302 is seated in front of a display device 304 of a computing system. In some embodiments, the display device 304 includes a camera that can capture images of the viewing area 306. In other embodiments, a separate camera, or a group of cameras, can capture images of the viewing area 306. In FIG. 3A, the viewing area 306 includes a user 302, but does not include any unauthorized users or unauthorized devices.

FIG. 3B depicts a second user 316 in the viewing area 314. The authorization application 126 can detect the second user 316 by capturing an image from the camera that is proximate the display device 312. The authentication application 126 can then analyze the image to determine if the second user 316 is an unauthorized user. For example, the authentication application 126 may detect certain facial features of the second user 316 and compare the facial features of the second user to the facial features of each authorized user. If the facial features of the second user 316 do not match the facial features of any authorized users, the second user can be considered an unauthorized user. The authentication application 126 can then block the view of confidential content displayed on the display device 312.

FIG. 3C depicts a device 326 in the viewing area 324. The authentication application 126 can detect the device 326 by capturing an image from the camera that is proximate to the display device 322. The authentication application 126 can then analyze the image to determine if the device 326 is an unauthorized device. For example, a device with certain physical characteristics may be identified in the viewing area. The authentication application 126 may determine that the device contains an optical lens and that the device is an unauthorized recording device. The authentication application 126 can then block the view of the confidential content displayed on the display device 322.

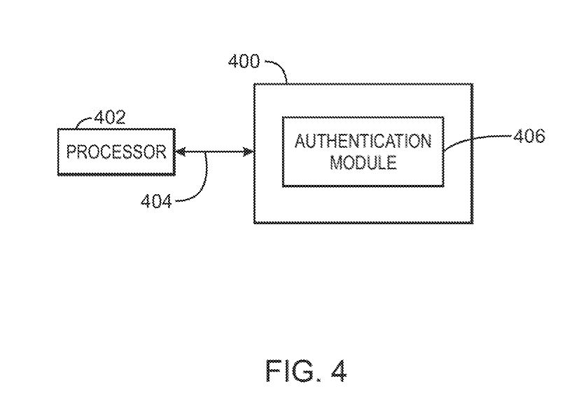

FIG. 4 is a block diagram showing a tangible, non-transitory, computer-readable medium 400 that allows continuous multi-factor authentication. The tangible, non-transitory, computer-readable medium 400 may be accessed by a processor 402 over a computer bus 404. Furthermore, the tangible, non-transitory, computer-readable medium 400 may include code to direct the processor 402 to perform the operations of the current method.

The various software components discussed herein may be stored on the tangible, non-transitory, computer-readable medium 400, as indicated in FIG. 4. For example, an authentication module 406 may be adapted to direct the processor 402 to allow continuous multi-factor authentication. It is to be understood that any number of additional software components not shown in FIG. 4 may be included within the tangible, non-transitory, computer-readable medium 400, depending on the specific application.

### EXAMPLE 1

A method for continuous multi-factor authentication is described herein. The method includes detecting a plurality of valid authentication credentials. The method also includes detecting an authorized user within a viewing area. Additionally, the method includes detecting an unauthorized object in the viewing area. Furthermore, the method includes preventing a display device from displaying content.

The method for continuous multi-factor authentication may simultaneously detect an authorized user and unauthorized objects. Also, the unauthorized objects may include any number of users and any number of devices. Alternatively, the method for continuous multi-factor authentication may detect unauthorized objects prior to detecting authorized users.

### EXAMPLE 2

A computing device is described herein. The computing device includes a processor that is adapted to execute stored instructions, a camera that is adapted to detect an image, and a storage device that stores instructions. The instructions stored in the storage device are adapted to detect a plurality of valid authentication credentials. The instructions are also adapted to detect an authorized user within a viewing area. Additionally, the instructions are adapted to detect an image of the viewing area from the camera. Furthermore, the instructions are adapted to detect a plurality of objects in the image. The instructions can also determine an object within the plurality of objects is an unauthorized object and prevent content from being displayed on a display device.

The computing device may contain a single camera or a group of cameras that can capture images of the viewing area. The computing device can then determine the number of objects in the viewing area and determine if the objects are authorized or unauthorized. The computing device can also determine the depth of the objects within the viewing area by analyzing the images captured by the cameras. Alternatively, the computing device may contain depth sensors that can determine the depth of objects in the viewing area.

### EXAMPLE 3

At least one machine readable medium having instructions stored therein is described herein. In response to being executed on a computing device, the instructions cause the computing device to detect a plurality of valid authentication credentials. The instructions also cause the computing device to detect an authorized user within a viewing area. Additionally, the instructions cause the computing device to detect an unauthorized object in the viewing area. Furthermore, the instructions cause the computing device to prevent content from being displayed on a display device.

Detecting an unauthorized object within a viewing area may include detecting a set of physical characteristics of an object and comparing the object's physical characteristics to the physical characteristics of the authorized users. In addition, detecting an unauthorized object within a viewing area may include determining the depth of the object in the viewing area. For example, unauthorized users may be detected, but it may be determined that the unauthorized users are located beyond the depth of the viewing area.

Although an example embodiment of the disclosed subject matter is described with reference to block and flow diagrams in FIGS. 1-4, persons of ordinary skill in the art will readily appreciate that many other methods of implementing the disclosed subject matter may alternatively be used. For example, the order of execution of the blocks in flow diagrams may be changed, and/or some of the blocks in block/flow diagrams described may be changed, eliminated, or combined.

In the preceding description, various aspects of the disclosed subject matter have been described. For purposes of explanation, specific numbers, systems and configurations were set forth in order to provide a thorough understanding of the subject matter. However, it is apparent to one skilled in the art having the benefit of this disclosure that the subject matter may be practiced without the specific details. In other instances, well-known features, components, or modules were omitted, simplified, combined, or split in order not to obscure the disclosed subject matter.

Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result.

For simulations, program code may represent hardware using a hardware description language or another functional description language which essentially provides a model of how designed hardware is expected to perform. Program code may be assembly or machine language, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Program code may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any tangible mechanism for storing, transmitting, or receiving information in a form readable by a machine, such as antennas, optical fibers, communication interfaces, etc. Program code may be transmitted in the form of packets, serial data, parallel data, etc., and may be used in a compressed or encrypted format.

Program code may be implemented in programs executing on programmable machines such as mobile or stationary computers, personal digital assistants, set top boxes, cellular telephones and pagers, and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments where tasks may be performed by remote processing devices that are linked through a communications network.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter.

What is claimed is:

1. A method for authentication, comprising:
detecting a plurality of valid authentication credentials;
detecting an authorized user within a viewing area;
detecting an unauthorized object in the viewing area; and
preventing a display device from displaying content.

2. The method of claim 1, wherein detecting an unauthorized object in the viewing area comprises detecting an unauthorized individual in the viewing area.

3. The method of claim 1, wherein detecting an unauthorized object in the viewing area comprises detecting an unauthorized device in the viewing area.

4. The method of claim 1, wherein preventing a display device from displaying content comprises displaying a single color.

5. The method of claim 1, wherein preventing a display device from displaying content further comprises:
determining a portion of the display device that displays the content; and
preventing the display of said portion of the display device.

6. The method of claim 1, further comprising monitoring the viewing area continuously for an unauthorized user.

7. The method of claim 1, further comprising monitoring the viewing area continuously for an unauthorized device.

8. A computing device, comprising:
a processor that is adapted to execute stored instructions;
a camera that is adapted to detect an image; and
a storage device that stores instructions, the storage device comprising
processor executable code that, when executed by the processor, is adapted to:
detect a plurality of valid authentication credentials;
detect an authorized user within a viewing area;
detect an image of the viewing area from the camera;
detect a plurality of objects in the image;
determine an object within the plurality of objects is an unauthorized object; and
prevent content from being displayed on a display device.

9. The computing device of claim 8, wherein the processor executable code is adapted to:
capture a plurality of consecutive images of the viewing area; and
monitor the plurality of consecutive images for an unauthorized user.

10. The computing device of claim 8, wherein the processor executable code is adapted to display a single color in response to detecting an unauthorized object in the viewing area.

11. The computing device of claim 8, wherein the processor executable code is adapted to:
determine the unauthorized object is an unauthorized user; and
prevent the content from being displayed.

12. The computing device of claim 8, wherein the processor executable code is adapted to:
determine a portion of a display device that displays the content; and
prevent the display of said portion of the display device.

13. The computing device of claim 8, wherein the processor executable code is adapted to:
capture a plurality of consecutive images of the viewing area; and
monitor the plurality of consecutive images for an unauthorized device.

14. The computing device of claim 8, wherein the processor executable code is adapted to:
determine the unauthorized object is an unauthorized device; and
prevent the content from being displayed.

15. At least one machine readable medium comprising a plurality of instructions that, in response to being executed on a computing device, cause the computing device to:
detect a plurality of valid authentication credentials;
detect an authorized user within a viewing area;
detect an unauthorized object in the viewing area; and
prevent content from being displayed on a display device.

16. The machine readable medium of claim 15,wherein the instructions further cause the computing device to:
detect an unauthorized device in the viewing area; and
prevent the content from being displayed on the display device.

17. The machine readable medium of claim 15 wherein the instructions further cause the computing device to:
determine a depth of an unauthorized individual;
determine a depth of the viewing area; and
prevent content from being displayed when the unauthorized individual is located within the depth of the viewing area.

18. The machine readable medium of claim 15,wherein the instructions further cause the computing device to monitor the viewing area continuously for an unauthorized User.

19. The machine readable medium of claim 15,wherein the instructions further cause the computing device to monitor the viewing area continuously for an unauthorized device.

20. The machine readable medium of claim 15, wherein the instructions further cause the computing device to display a single color.
